(19) United States
(12) Patent Application Publication
(10) Pub. No.: US 2016/0272095 A1
(43) Pub. Date: Sep. 22, 2016

(54) SEAT CUSHION FOR A PASSENGER SEAT

(71) Applicant: Franz Kiel GmbH, Noerdlingen (DE)

(72) Inventor: Juergen Mill, Ellwangen (DE)

(21) Appl. No.: 14/663,557

(22) Filed: Mar. 20, 2015

(51) Int. Cl. B60N 2/58; B60N 2/64

(52) U.S. Cl. CPC B60N 2/5833; B60N 2/646

(57) ABSTRACT

A seat cushion for a passenger seat has a seat shell made of a plastic material and an upholstery attached to the seat shell. The seat shell has a plurality of hooks on the side facing away from the upholstery. The upholstery has a circumferential ribbon made of an elastic material which is provided with holes, into which the hooks engage when the upholstery is mounted onto the seat shell.

The invention relates to a seat cushion for a passenger seat having a seat shell and an upholstery attached to the seat shell.

### BACKGROUND

U.S. Pat. No. 5,716,096 discloses a seat cover assembly having a seat envelope with a drawstring sheath and a slidable drawstring inside the sheath. The seat envelope surrounds a seat, and front and rear attachment projections on the seat facilitate attachment of the seat envelope to the seat. A webbing strip joins the drawstring sheath to the seat envelope and a plurality of slits are disposed in the webbing strip and apart from the drawstring sheath for attachment to the projections on the seat.

U.S. Pat. No. 5,338,092 discloses a seat cover assembly.

U.S. Pat. No. 5,768,758 describes a method and apparatus for securing upholstery or some other fabric to a seat having a frame, such as an automobile seat. The apparatus includes an elongated web of material having a cord incorporated therein which extends in the direction of elongation of the web and which may be extracted at various points along the length of the web. Hooks are provided on the underside of the seat, to which the web is attached. The web may be either elastic or nonelastic, and the cord may be either elastic or nonelastic. Non-elastic cord is used, an extra length of cord may be incorporated into the web. The web may be knitted, woven or braided. A web with an incorporated cord is secured to an edge of the upholstery which is desired to be secured to a seat. The cord is extracted from the web at preselected points and attached to a fastening device.

All these solutions use drawstrings placed in drawstring sheaths which are knotted at their ends and are secured to posts in the seat. This makes the mounting of the envelope to the seat rather time consuming.

Therefore, the problem addressed by the invention is to create a seat cushion for a passenger seat having an upholstery and a seat shell, wherein the upholstery can be easily attached to the seat shell.

According to the invention, said problem is solved by the features mentioned in claim 1.

By using a circumferential ribbon made of an elastic material and provided with holes, the upholstery can very easily be attached to the hooks located on the seat shell. This way, the upholstery can be changed very easily and quickly, which is advantageous particularly with passenger seats that are increasingly exposed to rampant vandalism.

By means of the elasticity of the circumferential ribbon, tolerance that occurs during the production of the seat shell and the ribbon, and particularly while attaching the ribbon to the upholstery, can be compensated, so that the upholstery can be connected to the seat shell very exactly.

Attaching the upholstery to the seat shell by means of the circumferential ribbon made of the elastic material provided with holes is particularly useful with seat shells consisting of such a plastic material, where the upholstery can be connected to the seat shell by means of staples or the like.

In an advantageous development of the invention, the holes can be designed as elongated slits. Such elongated slits can be inserted into the circumferential ribbon made of the elastic material very easily.

In this case, the ribbon made of the elastic material can be produced by means of weaving, and the holes can be inserted into the ribbon made of the elastic material during the weaving process of same. This allows for an easy insertion of the holes into the elastic ribbon, especially in the form of longitudinal slits.

To further facilitate the mounting of the upholstery to the seat shell, it can furthermore be provided that the distance between the holes in the circumferential ribbon at least approximately equals the distance between the hooks of the seat shell.

With regard to the easy and secure mounting of the circumferential ribbon made of an elastic material on the hooks of the seat shell, it has proven useful if the ribbon made of the elastic material is a stranded rubber.

If, in a further advantageous embodiment of the invention, the ribbon made of the elastic material is sewn together with the upholstery, then an easy-to-execute connection between the ribbon and the upholstery is realized.

The seat shell can be produced by means of injection moulding. This concerns an easy procedure that allows for a very economical way of very accurately producing seat shells out of plastic material.

To facilitate the production, it can be provided to create the hooks during the injection moulding.

The seat shell can furthermore have a plurality of connection elements located on the side facing away from the upholstery, for connecting the seat shell with a carrier section of a passenger seat. This allows for an easy connection of the seat shell with the body of the passenger seat.

In this case, this results in an easy mounting if the connection elements are provided as clip connections.

### BRIEF DESCRIPTION OF THE DRAWINGS

Other advantages of the present invention will be readily appreciated as the same becomes better understood by reference to the following detailed description when considered in connection with the accompanying drawings, wherein

FIG. 1 shows a side view of a passenger seat, and

FIG. 2 shows a perspective view of a seat cushion according to the present invention.

### DETAILED DESCRIPTION

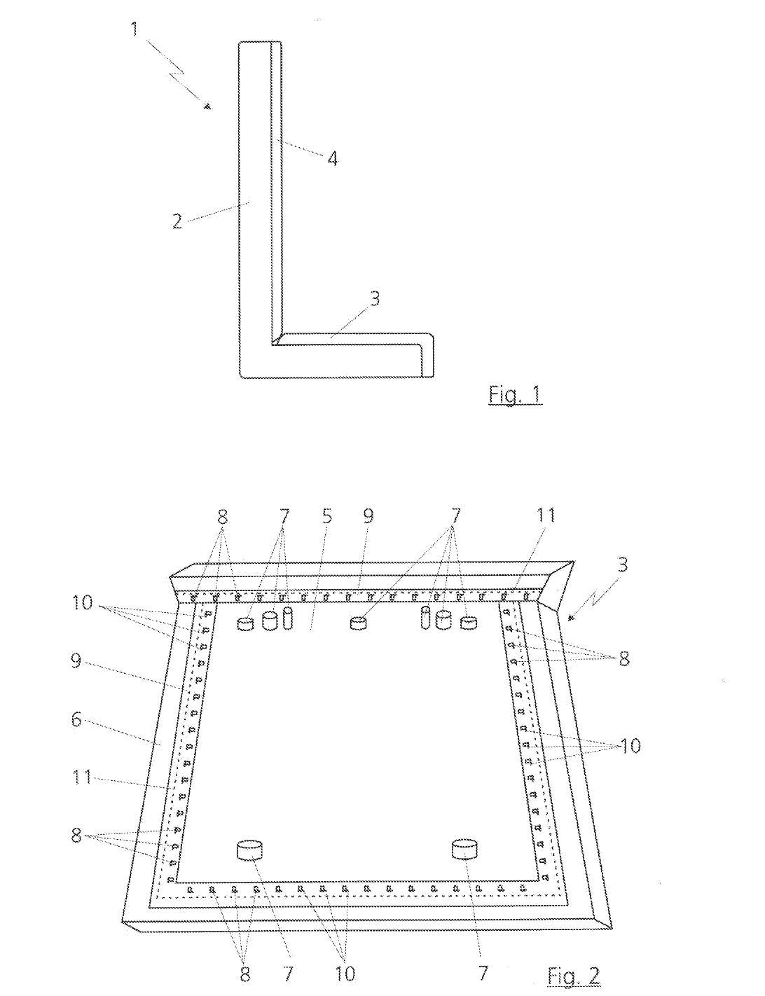

FIG. 1 shows a side view of a passenger seat 1, which is intended particularly for use in public transportation such as subways, trains, city buses and the like. It goes without saying that additional usages for the passenger seat 1 are also possible. The passenger seat 1 in the present case has an essentially L-formed carrier section 2 and two seat cushions 3 and 4 attached to the carrier section 2. In this case, the horizontally aligned seat cushion 3 is provided for stabilizing the buttocks, and the vertically aligned seat cushion 4 is provided for stabilizing the back of a passenger. The term “seat cushion” therefore comprises both a cushion for stabilizing the buttocks and a cushion for stabilizing the back. In principle, it would be possible to provide solely a single seat cushion, which could then serve for stabilizing the buttocks and the back. The passenger seat 1 could furthermore also be designed such that it provides support only to the buttocks and has no back part. In such a case only the horizontally aligned seat cushion 3 would be provided.

FIG. 2 shows the seat cushion 3 illustrated in FIG. 1 from a perspective bottom view. The seat cushion 3 is therefore depicted in FIG. 2 with its bottom side upwards. The seat cushion 4 for the back can be designed in a very similar way to the seat cushion 3 for the buttocks that will be described in detail below. It can be seen that the seat cushion 3 has a seat shell 5 and an upholstery 6 attached to the seat shell 5. On the side facing away from the upholstery, the seat shell 5 has several connection elements 7, only schematically indicated in the upper area of FIG. 2, which serve to connect the seat shell 5 with the carrier section 2 of the passenger seat 1. The connection elements 7 could be designed, for example, as clip connections and engage in respective recesses or the like in the carrier section 2. It goes without saying that the number, the arrangement, and the form of the connection elements 7 can differ from the illustrated. Basically, a threaded joint of the seat shell 5 of the seat cushion 3 and the carrier section 2 is also possible, wherein in this case, the connection elements 7 can also be designed in a similar form.

In addition, the seat shell 5 has several hooks 8 on the side facing away from the upholstery 6, which serve to enable attachment of the upholstery 6 to the seat shell 5 in the below described way. For this purpose, the upholstery 6 has a circumferential ribbon 9 consisting of an elastic material and having a plurality of holes 10, into which the hooks 8 engage when the upholstery 6 is mounted onto the seat shell 5. Said mounted condition of the upholstery 6 onto the seat shell 5 is illustrated in FIG. 2. Preferably, the holes 10 in the circumferential ribbon 9 attached to the upholstery 6 are at least approximately the same distance from each other as the hooks 8 of the seat shell 5. This way, an easy mounting of the upholstery 6 onto the seat shell 5 is made possible.

In the present case, the seat shell 5 is produced by means of injection moulding, particularly by means of high pressure injection moulding. Preferably, both the connection elements 7 and the hooks 8 are also already created during the injection moulding. As a material for the seat shell 5, a polyamide has proven especially suitable. A certain percentage of fibrous material, such as glass fiber, can be incorporated into the polyamide. In this respect, a material having the designation PA6 GF30 can be used. Said plastic material meets extremely high demands with regard to fire prevention. The material concerned could be, for example, the Lanxess company's Durethan® 1802.

The material 9 consisting of the elastic ribbon is preferably made by means of weaving. In this case, the holes 10 are incorporated into the ribbon 9 during weaving of same. It is deemed particularly preferable if the circumferential ribbon 9 made of elastic material is a stranded rubber. In the present case, the holes 10 are realized as elongated slits, so that a very simple weaving method can be used for producing the ribbon 9 having the holes 10. The circumferential ribbon 9 made of the elastic material is preferably sewn together with the upholstery 6. A corresponding seam is marked with reference sign 11 in FIG. 2.

Between the upholstery 6 and the seat shell 5, a cushioning material, e.g. a foam, can be located, however this is not depicted in the figures. Said foam can, for example, be a cut foam or a molded foam.

1. Seat cushion for a passenger seat having a seat shell made of a plastic material, and having an upholstery attached to the seat shell, wherein the seat shell has a plurality of hooks on the side facing away from the upholstery, and wherein the upholstery has a circumferential ribbon made of an elastic material, wherein said ribbon is provided with holes, into which the hooks engage when the upholstery is mounted onto the seat shell.

2. Seat cushion according to claim 1, wherein the holes are realized as elongated slits.

3. Seat cushion according to claim 1, wherein the ribbon made of the elastic material is produced by means of weaving, and wherein the holes are inserted into the circumferential ribbon made of the elastic material during the weaving process of same.

4. Seat cushion according to claim 1, wherein the distance between the holes in the circumferential ribbon at least approximately equals the distance between the hooks of the seat shell.

5. Seat cushion according to claim 1, wherein the ribbon made of the elastic material is a stranded rubber.

6. Seat cushion according to claim 1, wherein the ribbon made of the elastic material is sewn together with the upholstery.

7. Seat cushion according to claim 1, wherein the seat shell is produced by means of injection moulding.

8. Seat cushion according to claim 7, wherein the hooks are created during injection moulding.

9. Seat cushion according to claim 1, wherein the seat shell on the side facing away from the upholstery has a plurality of connection elements for connecting the seat shell with a carrier section of a passenger seat.

10. Seat cushion according to claim 9, wherein the connection elements are realized as clip connections.
